(19) United States
(12) Patent Application Publication
(10) Pub. No.: US 2011/0004473 A1
(43) Pub. Date: Jan. 6, 2011

(54) APPARATUS AND METHOD FOR ENHANCED SPEECH RECOGNITION

(75) Inventors: Ronen Laperdon, Kiriat Tivon (IL); Moshe Wasserblat, Maccabim (IL); Shimrit Artzi, Ra'anana (IL); Yuval Lubowich, Ra'anana (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: Nice Systems Ltd., Raanana (IL)

(21) Appl. No.: 12/497,718

(22) Filed: Jul. 6, 2009

(51) Int. Cl. G10L 15/06; G10L 15/04; G10L 17/00; G06F 17/30

(52) U.S. Cl. 704/243; 704/250; 704/254; 704/270; 704/E17.001; 704/E15.007; 707/759; 707/769; 707/760; 707/722

(57) ABSTRACT

A method and apparatus for improving speech recognition results for an audio signal captured within an organization, comprising: receiving the audio signal captured by a capturing or logging device; extracting a phonetic feature and an acoustic feature from the audio signal; decoding the phonetic feature into a phonetic searchable structure; storing the phonetic searchable structure and the acoustic feature in an index; performing phonetic search for a word or a phrase in the phonetic searchable structure to obtain a result; activating an audio analysis engine which receives the acoustic feature to validate the result and obtain an enhanced result.

### TECHNICAL FIELD

The present invention relates to speech recognition in general, and to an apparatus and method for improving the accuracy of speech recognition, in particular.

### BACKGROUND

Large organizations, such as banks, insurance companies, credit card companies, law enforcement agencies, service centers, or others, often employ or host contact centers or other units which hold numerous interactions with customers, users, suppliers or other persons on a daily basis. Many of the interactions are vocal or contain a vocal part. Such interactions include phone calls made using all types of phone equipment such as landline, mobile phones, voice over IP and others, recorded audio events, walk-in center events, video conferences, e-mails, chats, audio segments downloaded from the internet, audio files or streams, the audio part of video files or streams or the like.

Many organizations record some or all of the interactions, whether it is required by law or regulations, for quality assurance or quality management purposes, or for any other reason.

Once the interactions are recorded, the organization may want to yield as much information as possible from the interactions, including for example transcribing the interactions and analyzing the transcription, detecting emotional parts within interactions, or the like. One common usage for such recorded interactions relates to speech recognition and in particular to searching for particular words pronounced by either side of the interactions, such as product or service name, a competitor or competing product name, words expressing emotions such as anger or joy, or the like.

Searching for words can be done in two phases: indexing the audio, and then searching the index for words. In some embodiments, the indexing and searching are phonetic, i.e. during indexing the phonetic elements of the audio are extracted, and can later on be searched. Unlike word indexing, phonetic indexing and phonetic search enable the searching for words unknown at indexing time, such as names of new competitors, new slang words, or the like.

Storing all these interactions for long periods of time, takes up huge amount of storage space. Thus, an organization may decide to discarded the interactions or some of them after indexing, leaving only the phonetic index for future searches. However, such later searches are limited since the spotted words can not be verified, and additional aspects thereof can not be retrieved once the audio files are unavailable anymore.

There is thus a need in the art for a method and apparatus for enhancing speech recognition based on phonetic search, and in particular enhancing its accuracy.

### SUMMARY

A method and apparatus for improving speech recognition results by storing phonetic decoding of an audio signal, as well as acoustic features extracted from the signal. The acoustic features can later be used for executing further analyses to verify or discard phonetic search results.

In accordance with a first aspect of the disclosure there is thus provided a method for improving speech recognition results for one or more audio signals captured within an organization, the method comprising: receiving an audio signal captured by a capturing or logging device; extracting one or more phonetic features and one or more acoustic features from the audio signal; decoding the phonetic features into a phonetic searchable structure; and storing the phonetic searchable structure and the acoustic features in an index. The method can further comprise: performing phonetic search for a word or a phrase in the phonetic searchable structure to obtain a result; and activating one or more audio analysis engines which receive the acoustic feature to validate the result and obtain an enhanced result. The method can further comprise outputting the enhanced result. Within the method, the enhanced result is optionally used for quality assurance or quality management of a personnel member associated with the organization. Within the method, the enhanced result is optionally used for retrieving business aspects of one or more products or services offered by the organization or a competitor thereof. The method can further comprise an examination result step for examining the result and determining the audio analysis engine to be activated and the acoustic feature. Within the method, the audio analysis engine is optionally selected from the group consisting of: pre processing engine; post processing engine; language detection; and speaker detection. Within the method, the acoustic feature is optionally selected from the group consisting of: pitch mean; pitch variance, Energy mean; energy variance; Jitter; shimmer; speech rate; Mel frequency cepstral coefficients, Delta Mel-frequency cepstral coefficients; Shifted Delta Cepstral coefficients; energy; music; tone and noise. Within the method, the phonetic feature is optionally selected from the group consisting of: Mel-frequency cepstral coefficients (MFCC), Delta MFCC, and Delta Delta MFCC. The method can further comprise a step of organizing the acoustic feature prior to storing.

In accordance with another aspect of the disclosure there is thus provided an apparatus for improving speech recognition results for one or more audio signals captured within an organization, the apparatus comprising: a component for extracting an phonetic feature from an audio signal; a component for extracting an acoustic feature from the audio signal; and a phonetic decoding component for generating a phonetic searchable structure from the phonetic feature. The apparatus can further comprise a component for searching for word or a phrase within the searchable structure; and a component for activating an audio analysis engine which receives the acoustic feature and validates the result, and for obtaining an enhanced result. The apparatus can further comprise a spotted word or phrase examination component. Within the apparatus, the audio analysis engine is optionally selected from the group consisting of: pre processing engine: post processing engine; language detection; and speaker detection. Within the apparatus, the acoustic feature is optionally selected from the group consisting of: pitch mean; pitch variance, Energy mean; energy variance; Jitter; shimmer; speech rate; Mel-frequency cepstral coefficients, Delta Mel-frequency cepstral coefficients; Shifted Delta Cepstral coefficients; energy; music; tone and noise. Within the apparatus, the phonetic feature is optionally selected from the group consisting of: Mel-frequency cepstral coefficients (MFCC), Delta MFCC, and Delta Delta MFCC.

Yet another aspect of the disclosure relates to a method for improving speech recognition results for one or more audio signals captured within an organization, the method comprising: receiving an audio signal captured by a capturing or logging device; extracting one or more phonetic features and one or more acoustic feature from the audio signal; decoding the phonetic features into a phonetic searchable structure; storing the phonetic searchable structure and the acoustic features in an index; performing phonetic search for a word or a phrase in the phonetic searchable structure to obtain a result; and activating one or more audio analysis engine which receive the acoustic features to validate the result and obtain an enhanced result.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a block diagram of the main components in a typical environment in which the disclosed method and apparatus are used;

FIG. 2 is a flowchart of the main steps in a method for indexing audio files, in accordance with the disclosure;

FIG. 3 is a flowchart of the main steps in a method for searching the index generated upon an audio file, in accordance with the disclosure; and

FIG. 4 is a block diagram of the main components operative in enhanced phonetic indexing and search, in accordance with the disclosure.

### DETAILED DESCRIPTION

An apparatus and method for improving the accuracy of phonetic search within a phonetic index generated upon an audio source.

An audio source, such as an audio stream or file may undergo phonetic indexing which generates a phoneme lattice upon which phoneme sequences can later be searched. However, the results of the search within the lattice may be inaccurate, and may specifically have false positives, i.e. a word is recognized although it was not said. Such false positive can be the result of a similar word being pronounced, tones, music, poor audio quality or any other reason.

If the audio source is available at searching time, then such spotted words can be verified, either by a human operator or by activating one or more other audio analysis algorithms, such as pre-processing, post-processing, emotion detection, language identification, speaker detection, and others. For example, an emotion detection algorithm can be applied in order to confirm, or raise the confidence, that a highly emotional spotted word was indeed pronounced.

However, it is often the situation that the audio source is not available anymore, and such verification can not be performed.

On the other hand, it is highly resource consuming to activate all available algorithms during indexing or at any other time when the audio source is still available. It does not make sense to a-priori activate all algorithms and store their results, since very little of this information will eventually be required for word spotting verification purposes, and due to the processing power required for these algorithms.

The disclosed method and apparatus extract during indexing or shortly before or after indexing, those features required for audio analysis algorithms, including for example pre-processing, post-processing, emotion detection, language identification, and speaker detection. The algorithms themselves are not operated, but rather the raw data upon which they can be activated is extracted and stored. The feature data is stored in association with the phonetic index, for example in the same file, in corresponding files, in one or more related databases, or the like.

The extracted features comprise but are not limited to acoustic features upon which audio analysis engines operate.

Then, when words are searched for within the phoneme index of a particular audio source, if the need rises to verify a particular word, the required algorithm is operated on the relevant features as extracted during or in proximity to indexing, and the verification is performed. For example, if a highly emotional word or phrase is detected, an emotion detection algorithm can be activated upon the feature vectors extracted from the corresponding segment of the audio source. If emotional level exceeding the average is indeed detected in this segment, the confidence assigned to the spotted words is likely to increase, and vice versa.

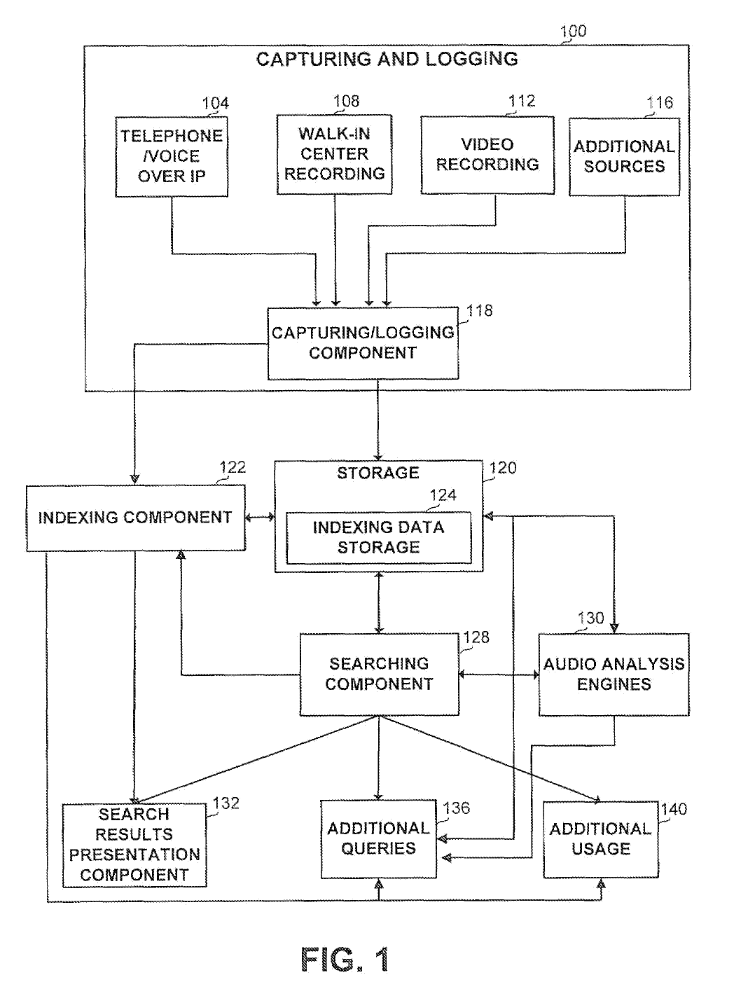

Referring now to FIG. 1, showing a typical environment in which the disclosed method and apparatus are used

The environment is preferably an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Segments, including interactions with customers, users, organization members, suppliers or other parties, and broadcasts are captured, thus generating audio input information of various types. The information types optionally include auditory segments, video segments comprising an auditory part, and additional data. The capturing of voice interactions, or the vocal part of other interactions, such as video, can employ many forms, formats, and technologies, including trunk side, extension side, summed audio, separate audio, various encoding and decoding protocols such as G729, G726, G723.1, and the like. The interactions are captured using capturing or logging components 100. The vocal interactions usually include telephone or voice over IP sessions 104. Telephone of any kind, including landline, mobile, satellite phone or others is currently the main channel for communicating with users, colleagues, suppliers, customers and others in many organizations, and a main source of intercepted data in law enforcement agencies. The voice typically passes through a PABX (not shown), which in addition to the voice of two or more sides participating in the interaction may collect additional information discussed below. A typical environment can further comprise voice over IP channels, which possibly pass through a voice over IP server (not shown). It will be appreciated that voice messages may be captured and processed as well, and that the handling is not limited to two- or more sided conversation. The interactions can further include face-to-face interactions, such as those recorded in a walk-in-center 108, video conferences comprising an auditory part 112, and additional sources of data 116. Additional sources 116 may include vocal sources such as microphone, intercom, vocal input by external systems, broadcasts, files, or any other source. Additional sources may also include non vocal sources such as e-mails, chat sessions, screen events sessions, facsimiles which may be processed by Object Character Recognition (OCR) systems. Computer Telephony Integration (CTI) information, or others.

Data from all the above-mentioned sources and others is captured and preferably logged by capturing/logging component 118. Capturing/logging component 118 comprises a computing platform executing one or more computer applications, which receives and captured the interactions as they occur, for example by connecting to telephone lines or to the PABX. The captured data is optionally stored in storage 120 which is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured segments and different types of additional data. The storage can be located onsite where the segments or some of them are captured, or in a remote location. The capturing or the storage components can serve one or more sites of a multi-site organization.

Storage 120 can comprise a single storage device or a combination of multiple devices. The apparatus further comprises indexing component 122 for indexing the interactions, i.e., generating a phonetic representation for each interaction or part thereof. Indexing component 122 is also responsible for extracting from the interactions the feature vectors required for the operation of other algorithms. Indexing component 122 operates upon interactions as received from capturing and logging component 112, or as received from storage 120 which may store the interactions after capturing.

A part of storage 120, or storage additional to storage 120 is indexing data storage 124 which stores the phonetic index and the feature vectors as extracted by indexing component 122. The phonetic index and feature vectors can be stored in any required format, such as one or more files such as XML files, binary files or others, one or more data entities such as database tables, or the like.

Yet another component of the environment is searching component 128, which performs the actual search upon the data stored in indexing data storage 124. Searching component 128 searches the indexing data for words, and then optionally improves the search results by activating any of audio analysis engines 130 upon the extracted feature vectors. Audio analysis engines 130 may comprise any one or more of the following engines: preprocessing engine operative in identifying music or tone sections, silent sections, sections of low quality or the like; emotion detection engine operative in identifying sections in which high emotion, whether positive or negative are exhibited; language identification engine operative in identifying a language spoken in an audio segment; and speaker detection engine operative in determining the speaker in a segment. It will be appreciated that analysis engines 130 can also comprise any one or more other engines, in addition to or instead of the engines detailed above.

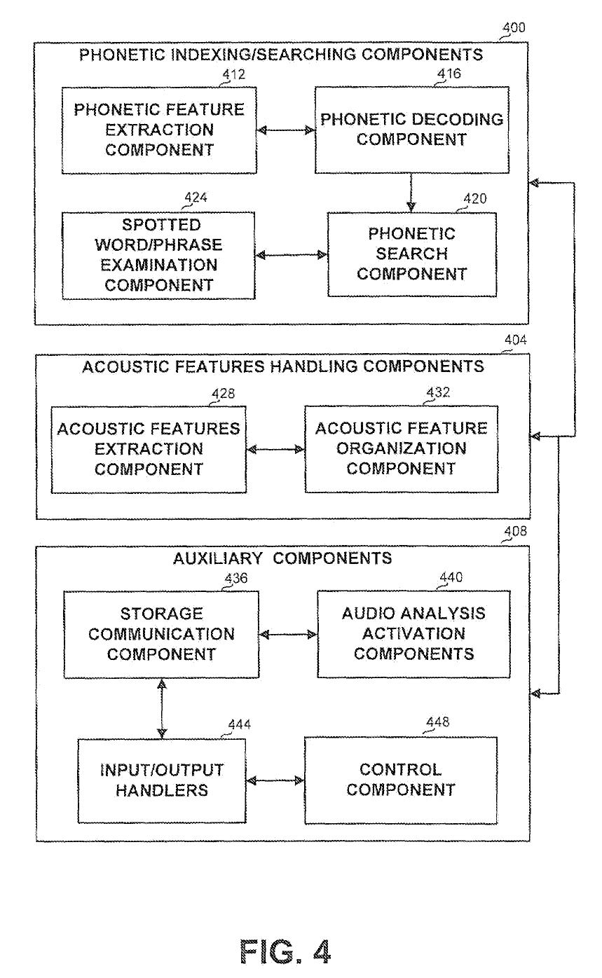

Indexing component 122 and searching component 128 are further detailed in association with FIG. 4 below.

The output of searching component 238 and optionally additional data are preferably sent to search result usage component 132 for any usage, such as presentation, textual analysis, root cause analysis, subject extraction, or the like. The feature vectors stored in indexing data 124, optionally with the output of searching components can be used for issuing additional queries 136, related only to results of audio analysis engines 130. For example, the feature vectors can be used for extracting emotional segments within an interaction or identifying a language spoken in an interaction, without relating to particular spotted words.

The results can also be sent for any other additional usage 140, such as statistics, presentation, playback, report generation, alert generation, or the like.

In some embodiments, the results can be used for quality management or quality assurance of a personnel member such as an agent associated with the organization. In some embodiments, the results may be used for retrieving business aspects a product or service offered by the organization or a competitor thereof. Additional usage components may also include playback components, report generation components, alert generation components, or others. The searching results can be further fed back and change the indexing performed by indexing component 122.

The apparatus preferably comprises one or more computing platforms, executing components for carrying out the steps of the disclosed method. Any computing platform can be a general purpose computer such as a personal computer, a mainframe computer, or any other type of computing platform that is provisioned with a memory device (not shown), a CPU or microprocessor device, and several I/O ports (not shown). The components are preferably components comprising one or more collections of computer instructions, such as libraries, executables, modules, or the like, programmed in any programming language such as C, C++, C#, Java or others, and developed under any development environment, such as .Net, J2EE or others. Alternatively, the apparatus and methods can be implemented as firmware ported for a specific processor such as digital signal processor (DSP) or microcontrollers, or can be implemented as hardware or configurable hardware such as field programmable gate array (FPGA) or application specific integrated circuit (ASIC). The software components can be executed on one platform or on multiple platforms wherein data can be transferred from one computing platform to another via a communication channel, such as the Internet, Intranet, Local area network (LAN), wide area network (WAN), or via a device such as CDROM, disk on key, portable disk or others.

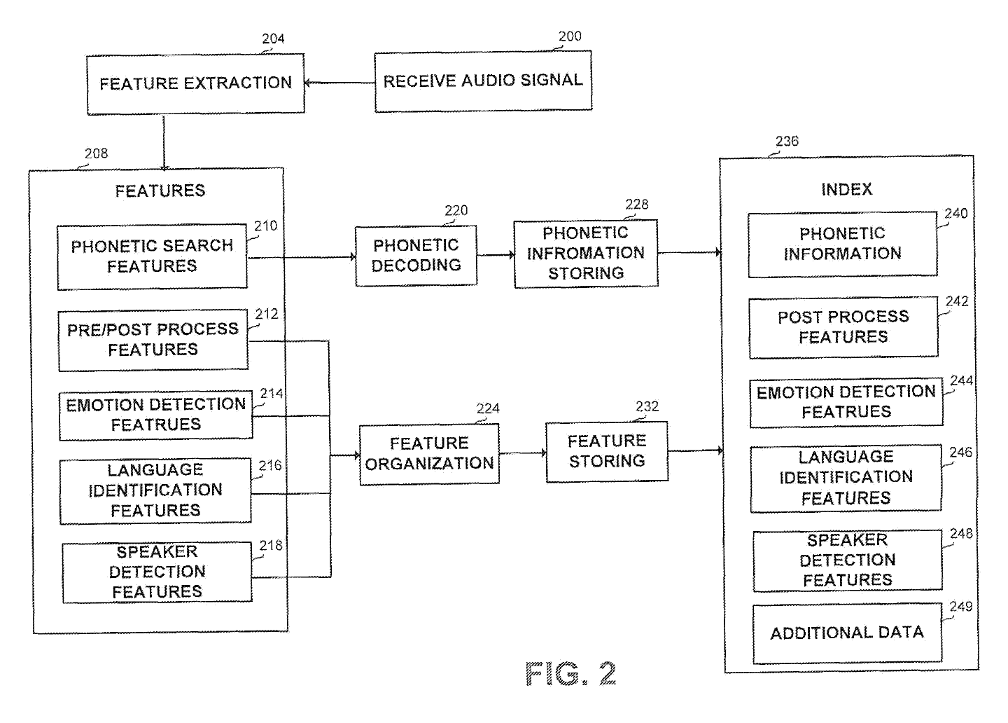

Referring now to FIG. 2, showing a flowchart of the main steps in phonetic indexing, in accordance with the disclosure.

The phonetic search starts upon receiving audio signal on step 200. The audio data can be received as one or more files, one or more streams, or any other source. The audio data can be received in any encoding and decoding protocol such as G729, G726, G723.1, or others. In some environments, the audio signal represents an interaction in a call center.

On step 204, features are extracted from the audio data. The features include phonetic features 210 required for phonetic indexing, such as Mel-frequency cepstral coefficients (MFCC), Delta MFCC and Delta Delta MFCC, as well as other features which may be required by other audio analysis engines or algorithms, and particularly acoustic features.

Feature extraction requires much less processing power and time than the relevant algorithms. Therefore, extracting the features, optionally when the audio source is already open for phonetic indexing implies little overhead on the system.

The additional features may include features required for any one or more of the engines detailed below, and in particular acoustic features. One engine is a pre/post processing engine, intended to remove audio segments of low quality, music, tones, or the like. Features 212 required for pre/processing may be selected but are not limited to provide for detecting any one or more of the following; low energy, music, tones or noise. If a word is spotted in such areas, its confidence is likely to be decreased, since phonetic search over such audio segments generally provides results which are deficient to other segments.

Another engine is emotion detection engine, for which the extracted features 214 may include one or more of the following: pitch mean or variance; energy mean or variance; jitter, i.e., the number of changes in the sign of the pitch derivative in a time window; shimmer, i.e., the number of changes in the sign of energy derivative in a time window; or speech rate, i.e., the number of voiced periods in a time window. Having features required for detecting emotional segments may help increase the confidence of words indicating that the user is in an emotional state, such as anger, joy, or the like.

Yet another engine is language detection engine, for which the extracted features 216 may include Mel-frequency cepstral coefficients (MFCC), Delta MFCC, or Shifted Delta Cepstral coefficients.

Yet another engine is speaker detection engine, for which the extracted features 218 may include Mel-frequency Cepstral coefficients (MFCC) or Delta MFCC.

It will be appreciated that some features may serve more than one of the algorithms. In which case it is generally enough to extract them once.

After feature extraction step 204, the phonetic features 210 undergo phonetic decoding on step 220, in which one or more data structures such as phoneme lattices are generated from each audio input signal or part thereof. The other features, which may include but are not limited to pre/post process features 212, emotion detection features 214, language identification features 216 or speaker detection features 218 are optionally organized on step 224, for example by collating similar or identical features, optimizing the features or the like.

On step 228 the phonetic information is stored in any required format, and on step 232 the other features are stored. It will be appreciated that storing steps 228 and 232 can be executed together or separately, and can store the phonetic data and the features together, for example in one index file, one database, one database table or the like, or separately.

The phonetic data and the features are thus stored in index 236, comprising phonetic information 240, pre/post process organized features 242, emotion detection organized features 244, language identification organized features 246 or speaker detection organized features 248. It will be appreciated that additional data 249, such as but not limited to CTI or Customer Relationship Management (CRM) data can also be stores within index 236.

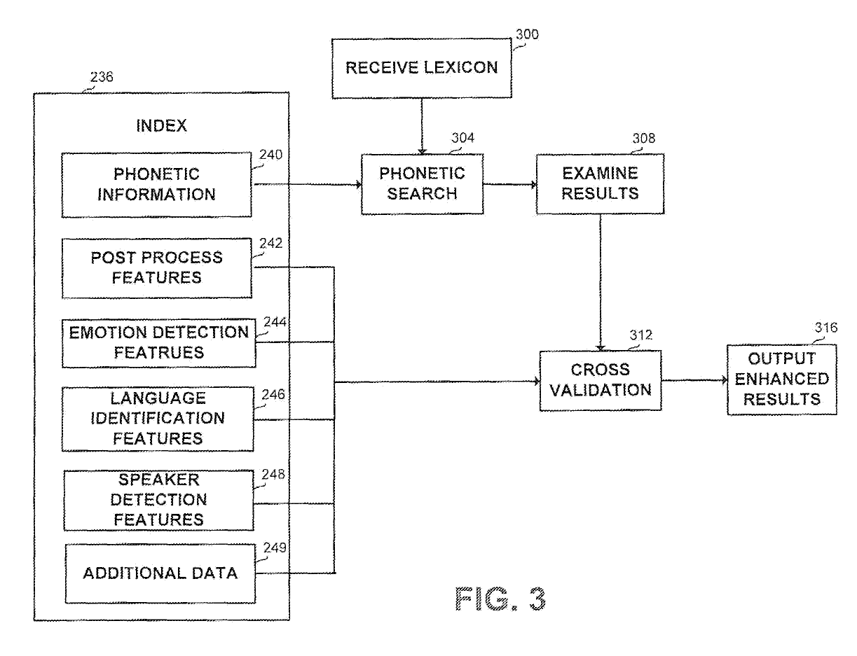

Referring now to FIG. 3, showing a flowchart of the main steps in phonetic searching, in accordance with the disclosure.

The input to the phonetic search comprises index 236, which contains phonetic information 240, and one or more of pre/post process organized features 242, emotion detection organized features 244, language identification organized features 246 speaker detection organized features 248, or additional data 249. It will be appreciated that index 236 can comprise features related to engines other than the engines listed above. The input further comprises lexicon, which contains one or more words to be searched within index 236. The words may comprise words known at indexing time, such as ordinary words in the language, as well as words not known at the time, such as new product names, competitor names, slang words or the like.

On step 300 the lexicon is received, and on step 304 phonetic search is performed within the index for the words in the lexicon. The search is optionally performed by splitting each word of the lexicon into its phonetic sequence, and looking for the phonetic sequence within phonetic information 240. Optionally, each found word is assigned a confidence score, indicating the certainty that the particular spotted words was indeed pronounced at the specific location in the audio input.

It will be appreciated that the phonetic search can receive as input a written word, i.e. a character sequence, or vocal input, i.e. an audio signal in which a word is spoken.

Phonetic search techniques can be found, for example, in “A fast lattice-based approach to vocabulary independent word spotting” by D. A. James and S. J. Young, published in IEEE International Conference on Acoustics, Speech, and Signal Processing. 1994 19-22 Apr. 1994 Pages 377-380, vol. 1, or in “Token passing: a simple conceptual model for connected speech recognition systems” by S. J. Young, N. H. Russell and J. H. S. Thornton (1989), Technical report CUED/F-INFENG/TR.38, CUED. Cambridge, UK., the full contents of which are incorporated herein by reference.

The results, indicating which word was found at which audio input and in which location and optionally the associated confidence score, are examined on step 308, either by a human operator or by a dedicated component. In accordance with the examination results, cross validation is performed on step 312 by activating any of the audio analysis engines which use features stored within index 236 other than phonetic information 240, and the final results are output on step 316.

In some embodiments, examination step 308 can, for example, check the confidence score of spotted words, and discard words having low score. Alternatively, if examination step 308 outputs that spotted words have low confidence score, cross validation step can activate the pre/post processing engine to determine whether the segment on which the words were spotted is a music/low energy/tone segment, in which case the words should be discarded. In some embodiments, if examination step 308 determines that the spotted words are emotional words, then emotion detection engine can be activated to determine whether the segment on which the words were spotted comprises high levels of emotions. In some embodiments, if examination step 308 determines that a spotted word belongs to a multiplicity of languages, or is similar to a word in another language then expected, then language identification engine can be activated to determine the language spoken in the segment.

It will be appreciated that multiple other rules can be activated by examination step 308 for determining whether and which audio analysis engines should be activated to provide additional indication whether the spotted words were indeed pronounced.

It will be appreciated that additional data 249 can also be used for such determination. For example, if a word was spotted on a segment indicated as a “hold” segment by the CTI information, then the word is to be discarded as well.

Activating the audio analysis engines on relatively short segments of the interactions, and wherein the feature vectors for such engines are already available increases the productivity and saves time and computing resources, while providing enhanced accuracy and confidence for the spotted words.

Referring now to FIG. 4, showing a block diagram of the main components operative in enhanced phonetic indexing and search, in accordance with the disclosure.

The components implement the methods of FIG. 2 and FIG. 3, and provide the functionality of indexing component 122 and searching component 128 of FIG. 1.

The main components include phonetic indexing and searching components 400, acoustic features handling components 404, and auxiliary or general components 408.

Phonetic indexing and searching components 400 comprise phonetic feature extraction component 412, for extracting features required for phonetic decoding, using for example Mel-frequency cepstral coefficients (MFCC), Delta MFCC, or Delta Delta MFCC. The phonetic decoding component 416, receives the extracted phonetic features and construct a searchable structure, such as a phonetic lattice associated with the audio input. Yet another component is phonetic search component 420, which is operative in receiving one or more words or phrases, breaking them into their phonetic sequence and looking within the searchable structure for the sequence. It will be appreciated that in some embodiments the phonetic search is performed also for sequences comprising phonemes close to the phonemes in the search word or phrase, and not only for the exact sequence.

Phonetic indexing and searching components 400 further comprise a spotted word or phrase examination component 424 for verifying whether a spotted word of phrase is to be accepted as is, or another engine should be activated on features extracted from at least a segment of the audio input which contains or is close to the spotted word.

Acoustic features handling components 404 comprise acoustic features extraction component 428 designed for receiving an audio signal and extracting one or more feature vectors. In some embodiments, acoustic features extraction component 428 splits the audio signal time frames, typically but not limited to having length of between about 10 and about 20 mSec, and then extracts the required features from each such time window.

Acoustic features handling components 404 further comprise phonetic features organization component 432 for organizing the features extracted by acoustic features extraction component 428 in order to prepare them for storage and retrieval.

Auxiliary components 408 comprise storage communication component 436 for communicating with a storage system such as a database, a file system or others, in order to store therein the searchable structure, the acoustic features or the organized acoustic features, and possibly additional data, and for retrieving the stored data from the storage system.

Auxiliary components 408 further comprise audio analysis activation component 440 for indications receiving from word or phrase validation component 424 and activating the relevant audio analysis engine on the relevant audio signal or part thereof, with the relevant parameters.

Auxiliary components 408 further comprise input and output handlers 444 for receiving the input, including the audio signals, the words to be searched for, the rules upon which additional audio analyses are to be performed, and the like, and for outputting the results. The results may include the raw spotted words, i.e., without activating any audio analysis, and the spotting results alter the validation by additional analysis. The results may also include intermediate data, and may be sent to any required destination or device, such as storage, display, additional processing or the like.

Yet another auxiliary component is control component 448 for controlling and managing the control and data flow between all components of the system, activating the required components with the relevant data, scheduling, or the like.

The disclosed methods and apparatus provide for high accuracy speech recognition in audio files. During indexing, phonetic features are extracted from the audio files, as well as acoustic features. Then, when a particular word is to be searched for, it is searched within the structure generated by the phonetic decoding component, and then it is validated whether a particular result needs further assessment. In such cases, an audio analysis engine is activated on the relevant acoustic features, and provides an enhanced or more accurate result.

It will be appreciated that the disclosed apparatus and methods are exemplary only and that further embodiments can be designed according to the same guidelines and concepts. Thus, different, additional or fewer components or analysis engines can be used, different features can be extracted, different rues can be applied to when and which audio analysis engines to activate, or the like.

It will be appreciated by a person skilled in the art that the disclosed apparatus is exemplary only and that multiple other implementations can be designed without deviating from the disclosure. It will be further appreciated that multiple other components and in particular extraction and analysis engines can be used. The components of the apparatus can be implemented using proprietary, commercial or third party products.

It will be appreciated by persons skilled in the art that the present invention is not limited to what has been particularly shown and described hereinabove. Rather the scope of the present invention is defined only by the claims which follow.

What is claimed is:

1. A method for improving speech recognition results for an at least one audio signal captured within an organization, the method comprising:
receiving the at least one audio signal captured by a capturing or logging device;
extracting at least one phonetic feature and at least one acoustic feature from the audio signal;
decoding the at least one phonetic feature into a phonetic searchable structure; and
storing the phonetic searchable structure and the at least one acoustic feature in an index.

2. The method of claim 1 further comprising:
performing phonetic search for a word or a phrase in the phonetic searchable structure to obtain a result; and
activating at least one audio analysis engine which receives the at least one acoustic feature to validate the result and obtain an enhanced result.

3. The method of claim 2 further comprising outputting the enhanced result.

4. The method of claim 2 wherein the enhanced result is used for quality assurance or quality management of a personnel member associated with the organization.

5. The method of claim 2 wherein the enhanced result is used for retrieving business aspects of at least one product or service offered by the organization or a competitor thereof.

6. The method of claim 2 further comprising an examination result step for examining the result and determining the audio analysis engine to be activated and the acoustic feature.

7. The method of claim 2 wherein the at least one audio analysis engine is selected from the group consisting of: pre processing engine; post processing engine; language detection; and speaker detection.

8. The method of claim 1 wherein the acoustic feature is selected from the group consisting of: pitch mean; pitch variance, Energy mean; energy variance; Jitter; shimmer; speech rate; Mel-frequency cepstral coefficients, Delta Mel-frequency cepstral coefficients; Shifted Delta Cepstral coefficients; energy; music; tone and noise.

9. The method of claim 1 wherein the phonetic feature is selected from the group consisting of: Mel-frequency cepstral coefficients (MFCC), Delta MFCC, and Delta Delta MFCC.

10. The method of claim 1 further comprising a step of organizing the acoustic feature prior to storing.

11. An apparatus for improving speech recognition results for an at least one audio signal captured within an organization, the apparatus comprising:
a component for extracting an phonetic feature from the at least one audio signal;
a component for extracting an acoustic feature from the at least one audio signal; and
a phonetic decoding component for generating a phonetic searchable structure from the phonetic feature.

12. The apparatus of claim 11 further comprising:
a component for searching for word or a phrase within the searchable structure; and
a component for activating an audio analysis engine which receives the acoustic feature and validates the result, and for obtaining an enhanced result.

13. The apparatus of claim 11 further comprising a spotted word or phrase examination component.

14. The apparatus of claim 12 wherein the audio analysis engine is selected from the group consisting of: pre processing engine; post processing engine; language detection; and speaker detection.

15. The apparatus of claim 11 wherein the acoustic feature is selected from the group consisting of: pitch mean; pitch variance, Energy mean; energy variance; Jitter; shimmer; speech rate; Mel-frequency cepstral coefficients, Delta Mel-frequency cepstral coefficients; Shifted Delta Cepstral coefficients; energy; music; tone and noise.

16. The apparatus of claim 11 wherein the phonetic feature is selected from the group consisting of: Mel-frequency cepstral coefficients (MFCC), Delta MFCC, and Delta Delta MFCC.

17. A method for improving speech recognition results for an at least one audio signal captured within an organization, the method comprising:
receiving the at least one audio signal captured by a capturing or logging device;
extracting at least one phonetic feature and at least one acoustic feature from the at least one audio signal;
decoding the at least one phonetic feature into a phonetic searchable structure;
storing the phonetic searchable structure and the at least one acoustic feature in an index;
performing phonetic search for a word or a phrase in the phonetic searchable structure to obtain a result; and
activating at least one audio analysis engine which receives the at least one acoustic feature to validate the result and obtain an enhanced result.
